(19) United States
(12) Patent Application Publication
(10) Pub. No.: US 2008/0226289 A1
(43) Pub. Date: Sep. 18, 2008

(54) Optical device testing

(76) Inventors: Stephan Meyer, San Francisco, CA (US); Manoj A. Patel, San Jose, CA (US); Matthew Figures, Modesto, CA (US); Travis J. Smith, Vernonia, OR (US)

Correspondence Address: CAVEN & AGHEVLI;c/o INTELLEVATE, LLC, P.O. BOX 52050, MINNEAPOLIS, MN, 55402, US

(21) Appl. No.: 11/724,680

(22) Filed: Mar. 15, 2007

(51) Int. Cl. H04B 17/00

(52) U.S. Cl. 398/16

(57) ABSTRACT

In one embodiment, an apparatus comprises a pattern generator to generate a test bit pattern in an electrical signal, an optical transponder to covert the electrical signal to an optical signal, transmit the optical signal to a device, and receive a processed test bit pattern from the device, and an error detector to analyze the processed test bit pattern to determine an error rate associated with the device.

### BACKGROUND

The subject matter described herein relates generally to the field of computing and more particularly to optical device testing.

Some semiconductor devices accept one or more optical input signals. The input signals may be converted to an electronic signal, then processed via one or more logic modules on the semiconductor device. Techniques to measure the accuracy of semiconductor devices would find utility.

### BRIEF DESCRIPTION OF THE DRAWINGS

The detailed description is described with reference to the accompanying figures.

FIG. 1 is a schematic illustration of an apparatus for optical device testing according to an embodiment.

FIG. 2 is a flowchart illustrating operations in an embodiment of a method for optical device testing.

FIG. 3 illustrates a block diagram of a computing system which may be used in conjunction with an embodiment of the invention.

### DETAILED DESCRIPTION

Described herein are exemplary systems and methods for rate adaptation in a communication system. In the following description, numerous specific details are set forth in order to provide a thorough understanding of various embodiments. However, it will be understood by those skilled in the art that the various embodiments may be practiced without the specific details. In other instances, well-known methods, procedures, components, and circuits have not been illustrated or described in detail so as not to obscure the particular embodiments.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and embodiments are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and embodiments are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and embodiments are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

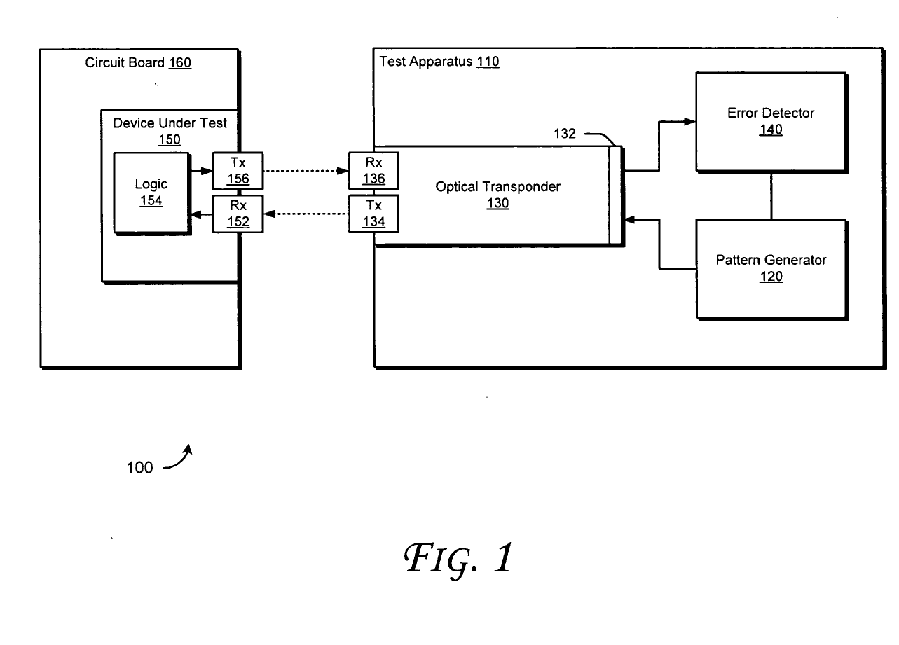

FIG. 1 is a schematic illustration of a system for optical device testing according to an embodiment. Referring to FIG. 1, in one embodiment system 100 comprises a test apparatus and a device under test 150. Test apparatus 110 comprises a pattern generator 120, an optical transponder 130, and an error detector 140 mounted on a circuit board 110.

In some embodiments, pattern generator 120 and error detector 140 may be implemented as logic instructions stored in a computer readable medium. For example, pattern generator 120 may be embodied as firmware that executes on a programmable logic device such as, e.g., a field programmable gate array (FPGA). Alternately, pattern generator 120 may be implemented as logic instructions stored in a computer readable medium that may be executed on a general purpose processor, or may be reduced to hard-wired logic such as, e.g., an application specific integrated circuit (ASIC).

Pattern generator is coupled to an optical transponder 130 by a suitable communication link such as, e.g., a circuit trace or one or more communication busses. In some embodiments, optical transponder 130 includes an interface such as, e.g., an XMGII/XAUI (10 Gigabit media independent interface/10 Gbps Ethernet attachment unit interface) interface, an optical receiver 134 and an optical transmitter 136.

Device under test 150 may be any opto-electronic device that receives and processes optical signals. For example, in some embodiments device under test 150 may be embodied as an integrated circuit (IC) that receives optical signals, converts the optical signals to electrical signals, processes the electrical signals, and generates an output signal. Device under test includes an optical receiver 152 and an optical transmitter coupled to at least one logic module 154. Logic module 154 may include an optical transponder to convert optical signals to electrical signals, and vise-versa. Device under test 150 may be mounted on a circuit board 160, which may include other components.

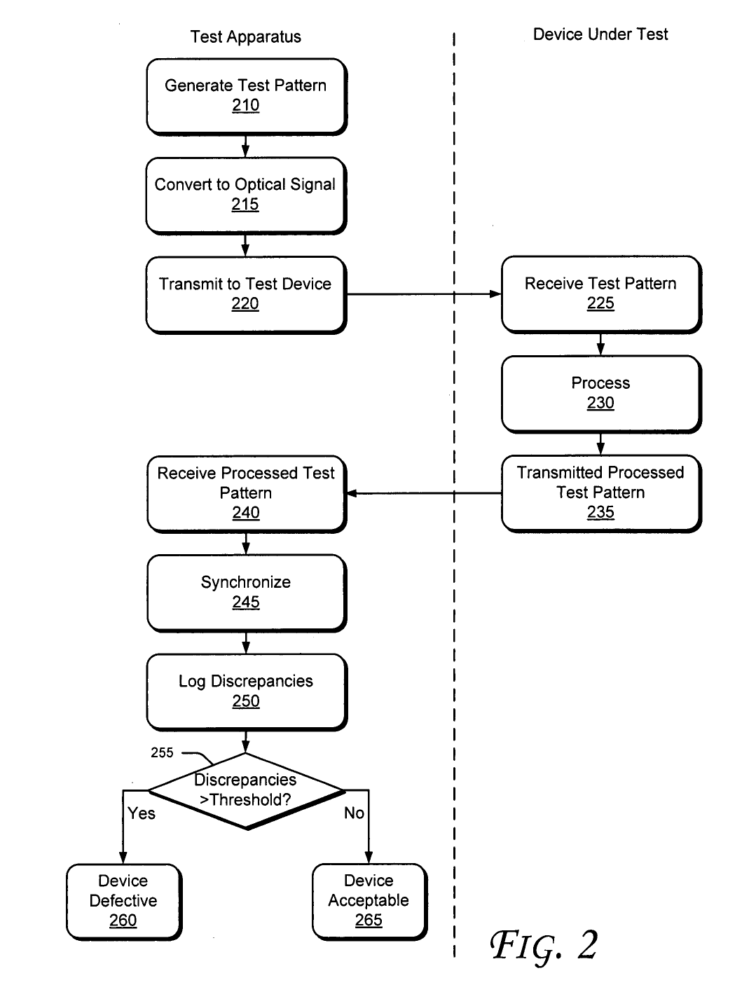

FIG. 2 is a flowchart illustrating operations in an embodiment of a method for optical device testing. Referring to FIG. 2, at operation 210 the pattern generator 120 generates an electrical signal that comprises a test bit pattern. In some embodiments, the test bit pattern may be implemented as a continuous jitter pattern (CJPAT), a continuous random pattern (CRPAT), or a pseudo-random binary sequence (PRBS), or a proprietary test pattern.

The test bit pattern is input to the interface 126 of the optical transponder 120, which at operation 215 converts the electrical signal to an optical signal. At operation 220 the optical transponder 120 inputs the optical signal to the transmitter 134, which transmits the optical signal. The optical signal may be transmitted (operation 220) via any medium suitable for an optical signal including an optical fiber or air.

At operation 225 the optical signal is received in the receiver 152 of the device under test 150. The received signal comprising the test bit pattern may be converted from an optical signal to an electrical signal. At operation 230 the device under test 150 processes the received signal. As used herein, the phrase processing the signal refers to applying one or more logic operations to the received signal. The specific logic operations applied by the device under test 150 are not material to the subject matter described herein. At operation 235 the processed test bit pattern is returned then transmitted by the transmitter 156.

At operation 240 the processed test bit pattern is received in the receiver 136 of optical transponder 130, which converts the optical signal back to an electrical signal. The electrical signal comprising the test bit pattern is then input to the error detector 140, which synchronizes (operation 245) the processed test bit pattern with an expected test bit pattern. For example, the expected test bit pattern may correspond to the pattern generated by pattern generator 120.

At operation 250 discrepancies between the processed test bit pattern and the expected test bit pattern are logged. For example, in some embodiments the error detector may perform a bit-by-bit comparison of the processed test bit pattern with the expected test bit pattern, and may record the instances in which the bits received in the processed test bit pattern differ from the bits in the expected test bit pattern.

If, at operation 255 the number of discrepancies between processed test bit pattern and the expected test bit pattern exceeds a threshold, then the device under test may be marked as defective (operation 260). By contrast, if at operation 255 the number of discrepancies between processed test bit pattern and the expected test bit pattern does not exceed a threshold, then the device under test may be marked as not defective (operation 265).

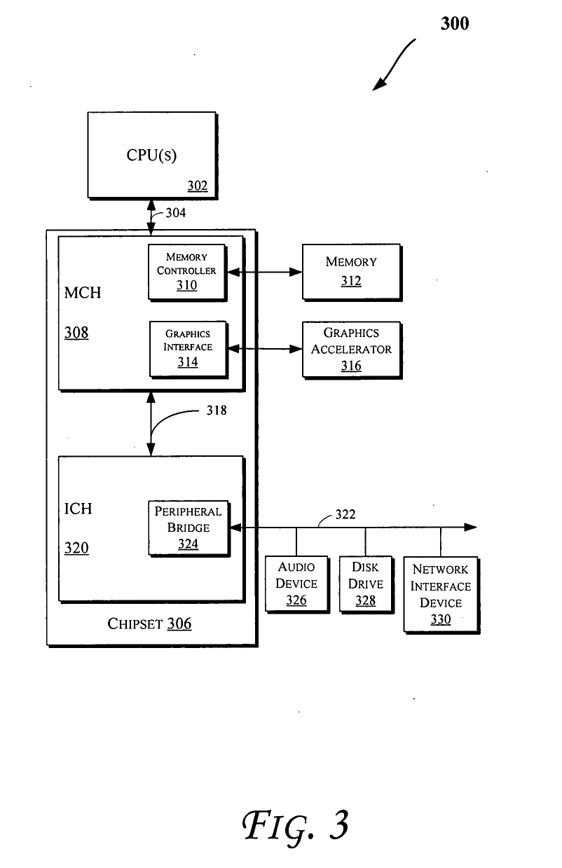

FIG. 3 illustrates a block diagram of a computing system 300 which may be used in conjunction with an embodiment of the invention. The computing system 300 may include one or more central processing unit(s) (CPUs) 302 or processors coupled to an interconnection network (or bus) 304. The processors (302) may be any suitable processor such as a general purpose processor, a network processor, or the like (including a reduced instruction set computer (RISC) processor or a complex instruction set computer (CISC)). Moreover, the processors (302) may have a single or multiple core design. The processors (302) with a multiple core design may integrate different types of processor cores on the same integrated circuit (IC) die. Also, the processors (302) with a multiple core design may be implemented as symmetrical or asymmetrical multiprocessors.

A chipset 306 may also be coupled to the interconnection network 304. The chipset 306 may include a memory control hub (MCH) 308. The MCH 308 may include a memory controller 310 that is coupled to a memory 312. The memory 312 may store data and sequences of instructions that are executed by the CPU 302, or any other device included in the computing system 300. In one embodiment of the invention, the memory 312 may include one or more volatile storage (or memory) devices such as random access memory (RAM), dynamic RAM (DRAM), synchronous DRAM (SDRAM), static RAM (SRAM), or the like. Nonvolatile memory may also be utilized such as a hard disk. Additional devices may be coupled to the interconnection network 304, such as multiple CPUs and/or multiple system memories.

The MCH 308 may also include a graphics interface 314 coupled to a graphics accelerator 316. In one embodiment of the invention, the graphics interface 314 may be coupled to the graphics accelerator 316 via an accelerated graphics port (AGP). In an embodiment of the invention, a display (such as a flat panel display) may be coupled to the graphics interface 314 through, for example, a signal converter that translates a digital representation of an image stored in a storage device such as video memory or system memory into display signals that are interpreted and displayed by the display. The display signals produced by the display device may pass through various control devices before being interpreted by and subsequently displayed on the display.

A hub interface 318 may couple the MCH 308 to an input/output control hub (ICH) 320. The ICH 320 may provide an interface to input/output (I/O) devices coupled to the computing system 300. The ICH 320 may be coupled to a bus 322 through a peripheral bridge (or controller) 324, such as a peripheral component interconnect (PCI) bridge, a universal serial bus (USB) controller, or the like. The bridge 324 may provide a data path between the CPU 302 and peripheral devices. Other types of topologies may be utilized. Also, multiple buses may be coupled to the ICH 320, e.g., through multiple bridges or controllers. Moreover, other peripherals coupled to the ICH 320 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or the like.

The bus 322 may be coupled to an audio device 326, one or more disk drive(s) 328, and a network interface device 330. Other devices may be coupled to the bus 322. Also, various components (such as the network interface device 330) may be coupled to the MCH 308 in some embodiments of the invention. In addition, the CPU 302 and the MCH 308 may be combined to form a single chip. Furthermore, the graphics accelerator 316 may be included within the MCH 308 in other embodiments of the invention.

Additionally, the computing system 300 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 328), a floppy disk, a compact disk ROM (CD-ROM), a digital versatile disk (DVD), flash memory, a magneto-optical disk, or other types of nonvolatile machine-readable media suitable for storing electronic instructions and/or data.

In various embodiments, one or more of the operations discussed herein, e.g., with reference to FIGS. 1-3, may be implemented as hardware (e.g., logic circuitry), software, firmware, or combinations thereof, which may be provided as a computer program product, e.g., including a machine-readable or computer-readable medium having stored thereon instructions used to program a computer to perform a process discussed herein.

Reference in the specification to “one embodiment” or “an embodiment” means that a particular feature, structure, or characteristic described in connection with the embodiment is included in at least an implementation. The appearances of the phrase “in one embodiment” in various places in the specification may or may not be all referring to the same embodiment.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An apparatus, comprising:
a pattern generator to generate a test bit pattern in an electrical signal;
an optical transponder to:
covert the electrical signal to an optical signal;
transmit the optical signal to a device; and
receive a processed test bit pattern from the device; and
an error detector to analyze the processed test bit pattern to determine an error rate associated with the device.

2. The apparatus of claim 1, wherein the pattern generator generates a test bit pattern comprising at least one of:
a constant jitter pattern:
a continuous random pattern;
a pseudo-random binary pattern.

3. The apparatus of claim 1, wherein the optical transponder comprises an XAUI compliant transponder.

4. The apparatus of claim 1, the optical transponder converts the processed test bit pattern from an optical signal to an electrical signal.

5. The apparatus of claim 1, wherein the pattern generator transmits, to the error detector, a signal which identifies the test bit pattern.

6. The apparatus of claim 5, wherein the error detector:
synchronizes the processed test bit pattern with an expected test pattern; and
counts a number of discrepancies between the test bit pattern and the expected test pattern.

7. A method to test a device, comprising:
transmitting a test bit pattern to the device;
processing the test bit pattern through the device to generate a processed test bit pattern; and
analyzing the processed test bit pattern in an error detector module to determine an error rate associated with the device.

8. The method of claim 7, wherein transmitting a test bit pattern to the device comprises:
generating an electronic signal comprising the test bit pattern; and
converting the electronic signal to an optical signal.

9. The method of claim 8, wherein generating an electronic signal comprising the test bit pattern comprises generating at least one of:
a constant jitter pattern:
a continuous random pattern;
a pseudo-random binary pattern.

10. The method of claim 8, wherein transmitting a test bit pattern to the device comprises passing the electronic signal through an XAUI compliant transponder.

11. The method of claim 10, further comprising converting the test bit pattern into a serial optical bitstream.

12. The method of claim 7, further comprising transmitting, to the error detector, a signal which identifies the test bit pattern.

13. The method of claim 7, wherein analyzing the processed test bit pattern to determine an error rate associated with the device comprises:
synchronizing the processed test bit pattern with an expected test pattern; and
counting a number of discrepancies between the test bit pattern and the expected test pattern.
